(19) United States
(12) Patent Application Publication
(10) Pub. No.: US 2023/0254620 A1
(43) Pub. Date: Aug. 10, 2023

(54) MICROPHONE DEVICE, AUDIO SIGNAL PROCESSING DEVICE, AND AUDIO SIGNAL PROCESSING METHOD

(71) Applicant: SONY GROUP CORPORATION, TOKYO (JP)

(72) Inventors: YOHEI SAKURABA, TOKYO (JP); YOSHIHIRO TAMURA, TOKYO (JP); HIDEAKI WATANABE, TOKYO (JP); KAZUHIRO MATSUTANI, TOKYO (JP); YASUHIKO KATO, TOKYO (JP); TAKESHI YAMAGUCHI, TOKYO (JP)

(21) Appl. No.: 18/004,738

(22) PCT Filed: Jul. 12, 2021
(86) PCT No.: PCT/JP2021/026073

§ 371 Date: Jan. 9, 2023

(30) Foreign Application Priority Data
Jul. 17, 2020 (JP) 2020-122546

(51) Int. Cl. H04R 1/08; H04R 1/26; H04R 1/32; H04R 3/00

(52) U.S. Cl. CPC H04R 1/083; H04R 1/265; H04R 1/326; H04R 3/00; H04R 2430/20

(57) ABSTRACT

Audio signal processing that satisfies both sound quality and cost is enabled.

A processing unit that performs processing based on an output audio signal of a first microphone unit focusing on sound quality and an output audio signal of a second microphone unit focusing on cost is included. For example, the processing performed by the processing unit includes processing of obtaining a beamforming output and processing of obtaining a sound source separation output. Furthermore, for example, the processing performed by the processing unit may include processing of generating a first audio signal on the basis of an output audio signal of the first microphone and processing of generating a second audio signal on the basis of output audio signals of a plurality of the second microphone units.

### TECHNICAL FIELD

The present technology relates to a microphone device, an audio signal processing device, and an audio signal processing method, and more particularly to a microphone device or the like that enables audio signal processing that satisfies both sound quality and cost.

### BACKGROUND ART

There are many technologies called beamforming for making directivity using a plurality of microphone units called a microphone array and products using the technology (see Patent Document 1, for example). The sound quality limit of this beamforming is determined by the microphone unit to be used. When a high-quality microphone unit focusing on sound quality is used, sound quality is good, but cost increases. When a standard microphone unit focusing on cost is used, cost is low, but sound quality is deteriorated. The same applies not only to beamforming but also to sound source separation processing of separating sound using a plurality of microphone units.

### CITATION LIST

### Patent Document

Patent Document 1: Japanese Patent Application Laid-Open No. 2017-192044

### SUMMARY OF THE INVENTION

### Problems to be Solved by the Invention

An object of the present technology is to enable audio signal processing that satisfies both sound quality and cost.

Solutions to Problems

A concept of the present technology is
a microphone device including
a first microphone unit and a second microphone unit having different sizes or different parameters related to sound quality.

In the present technology, a microphone device includes two types of microphone units. The two types of microphone units are a first microphone unit and a second microphone unit having different sizes or different parameters related to sound quality. For example, both the first microphone unit and the second microphone unit may be provided in one housing. Furthermore, for example, the first microphone unit and the second microphone unit may have different microphone diameters, frequency characteristics, self-noise levels, maximum input sound pressure levels, and the like. Furthermore, for example, the number of first microphone units may be one or two, and the number of second microphone units may be at least two.

As described above, the present technology includes the first microphone unit and the second microphone unit having different sizes or different parameters related to sound quality, and enables audio signal processing (e.g., beamforming processing, sound source separation processing, and the like) that satisfies both sound quality and cost.

Furthermore, another concept of the present technology is
an audio signal processing device including
a processing unit that performs processing based on an output audio signal of a first microphone unit and an output audio signal of a second microphone unit, in which
the first microphone unit and the second microphone unit have different sizes or different parameters related to sound quality.

In the present technology, the processing unit performs processing based on an output audio signal of a first microphone unit and an output audio signal of a second microphone unit. Here, the first microphone unit and the second microphone unit have different sizes or different parameters related to sound quality. For example, the audio signal processing device may further include a microphone device including the first microphone unit and the second microphone unit.

For example, the processing performed by the processing unit may include processing of obtaining a beamforming output. In this case, for example, the processing performed by the processing unit may include beamforming processing based on output audio signals of a plurality of the second microphone units, processing of calculating a change in an amplitude value and a phase of an audio signal obtained by the beamforming processing with respect to an output audio signal of a reference microphone which is one of the plurality of second microphone units, and processing of generating the beamforming output by applying the change in the amplitude value and the phase obtained by the calculation processing to the output audio signal of the first microphone unit.

Furthermore, in this case, for example, the processing performed by the processing unit may include processing of generating the beamforming output by performing adaptive beamforming using the first microphone unit as a reference microphone on the basis of output audio signals of a plurality of the second microphone units and the first microphone unit.

Furthermore, for example, the processing performed by the processing unit may be processing of obtaining a sound source separation output. In this case, for example, the processing performed by the processing unit may include sound source separation processing based on output audio signals of a plurality of the second microphone units, processing of calculating a change in an amplitude value and a phase of an audio signal obtained by the sound source separation processing with respect to an output audio signal of a reference microphone which is one of the plurality of second microphone units, and processing of generating the sound source separation output by applying the change in the amplitude value and the phase obtained by the calculation processing to the output audio signal of the first microphone unit.

Furthermore, in this case, for example, the processing performed by the processing unit may include processing of generating the sound source separation output by performing sound source separation using the first microphone unit as a reference microphone on the basis of output audio signals of a plurality of the second microphone units and the first microphone unit.

Furthermore, for example, the processing performed by the processing unit may include processing of generating a first audio signal on the basis of an output audio signal of the first microphone and processing of generating a second audio signal on the basis of an output audio signal of the second microphone unit.

As described above, in the present technology, processing based on the output audio signal of the first microphone unit and the output audio signal of the second microphone unit having a size or parameter regarding sound quality different from that of the first first microphone unit is performed, and audio signal processing (e.g., beamforming processing, sound source separation processing, and the like) that satisfies both sound quality and cost can be performed.

### BRIEF DESCRIPTION OF DRAWINGS

FIG. 1 is a block diagram illustrating a configuration example of an audio signal processing system 10 as an embodiment.

FIG. 2 is a diagram collectively illustrating an example of the difference between a high-quality microphone unit and a standard microphone unit.

FIG. 3 is a diagram illustrating a configuration example of a general audio signal processing system for obtaining a beamforming output.

FIG. 4 is a diagram illustrating a configuration example of an audio signal processing system as a specific example (1) of the embodiment.

FIG. 5 is a diagram illustrating a configuration example of an audio signal processing system as a specific example (2) of the embodiment.

FIG. 6 is a diagram illustrating a configuration example of an audio signal processing system as a specific example (3) of the embodiment.

FIG. 7 is a diagram illustrating a configuration example of an audio signal processing system as a specific example (4) of the embodiment.

FIG. 8 is a diagram illustrating a configuration example of an audio signal processing system as a specific example (5) of the embodiment.

### MODE FOR CARRYING OUT THE INVENTION

Hereinafter, modes for carrying out the invention (hereinafter referred to as embodiments) will be described. Note that the description will be given in the following order.

1. Embodiment

2. Modification

<1. Embodiment>

“Configuration Example of Audio Signal Processing System”

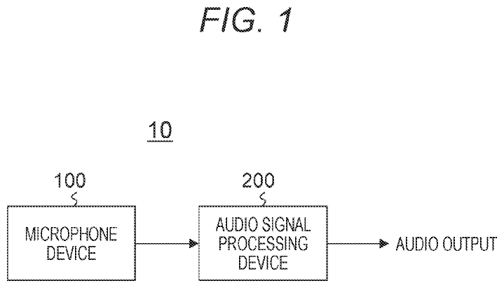

FIG. 1 illustrates a configuration example of an audio signal processing system 10 as an embodiment. The audio signal processing system 10 includes a microphone device 100 and a signal processing device 200.

The microphone device 100 includes a high-quality microphone unit (first microphone unit) focusing on sound quality and a standard microphone unit (second microphone unit) focusing on cost. In this case, both a microphone unit focusing on sound quality and a microphone unit focusing on cost are provided in the housing of the single microphone device 100. Here, the microphone unit focusing on sound quality and the microphone unit focusing on cost are microphone units having different sizes or different parameters related to sound quality. The microphone unit focusing on sound quality is larger in size and higher in sound quality than the microphone unit focusing on cost. For example, the number of microphone units focusing on sound quality is a small number such as one or two, and the number of microphone units focusing on cost is at least two.

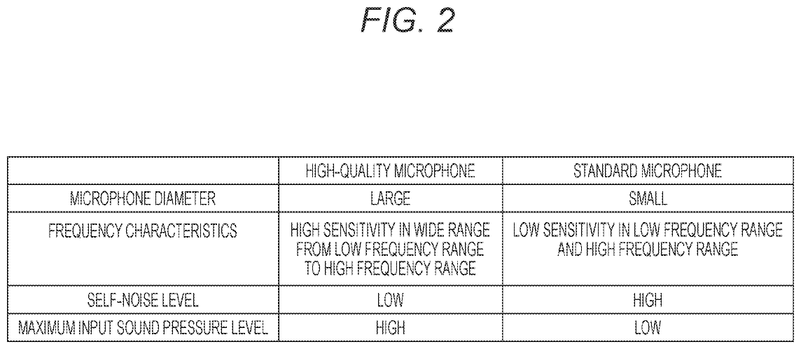

FIG. 2 collectively illustrates an example of the difference between a high-quality microphone unit focusing on sound quality and a standard microphone unit focusing on cost. As a parameter related to size, for example, regarding the microphone diameter, a high-quality microphone unit is large, and a standard microphone unit is small. As a parameter related to sound quality, for example, regarding frequency characteristics, a high-quality microphone unit has high sensitivity in a wide range from a low frequency range to a high frequency range, and a standard microphone unit has low sensitivity in a low frequency range and a high frequency range. Furthermore, as a parameter related to sound quality, for example, regarding the self-noise level, a high-quality microphone unit is low, and a standard microphone unit is high. Furthermore, as a parameter related to sound quality, for example, regarding the maximum input voltage level, a high-quality microphone unit is high, and a standard microphone unit is low.

Returning to FIG. 1, the audio signal processing device 200 performs processing based on an output audio signal of the high-quality microphone unit and an output audio signal of the standard microphone unit to obtain an audio output. For example, the audio signal processing device 200 performs processing of obtaining a beamforming output. Furthermore, for example, the audio signal processing device 200 performs processing of obtaining a sound source separation output. Furthermore, for example, in the audio signal processing device 200, processing based on an output audio signal of the high-quality microphone unit and processing based on an output audio signal of the standard microphone unit are performed.

“Specific Example of Audio Signal Processing System”

(A. Example of Performing Processing for Obtaining Beamforming Output)

An example in which the audio signal processing device 200 performs processing for obtaining a beamforming output will be described.

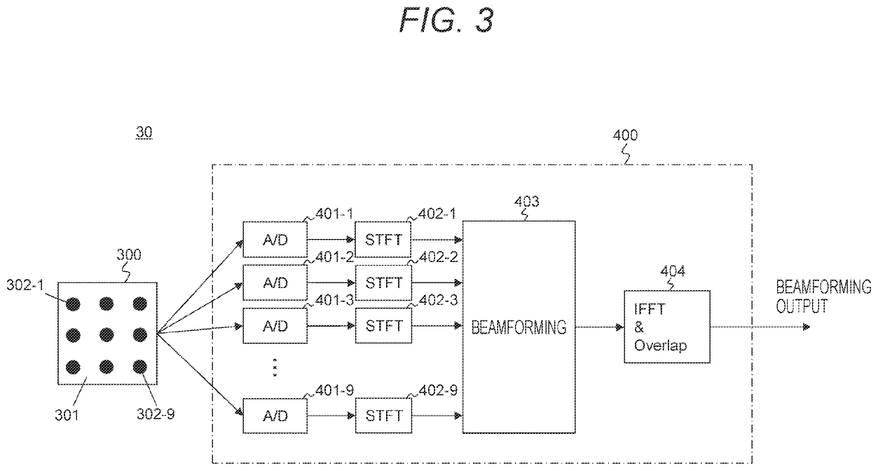

First, a configuration example of a general audio signal processing system 30 for obtaining a beamforming output will be described with reference to FIG. 3. The audio signal processing system 30 includes a microphone device 300 and an audio signal processing device 400.

The microphone device 300 includes, for a plurality of channels, that is, nine in the illustrated example, microphone units 302-1 to 302-9. Note that the number of microphone units may be any number as long as it is two or more, but in performing beamforming processing to be described later, a larger number of microphone units is advantageous in terms of sharpness of directivity. In the microphone device 300, the nine microphone units 302-1 to 302-9 are arranged in a 3 x 3 matrix in a microphone housing 301. The microphone device 300 outputs audio signals from the microphone units 302-1 to 302-9 in parallel.

The audio signal processing device 400 includes A/D converters 401-1 to 401-9, short term Fourier transform (STFT) units 402-1 to 402-9, a beamforming unit 403, and an IFFT & overlap unit 404.

The A/D converters 401-1 to 401-9 convert output audio signals of the microphone units 302-1 to 302-9 from analog signals to digital signals, respectively. Each of the STFT units 402-1 to 402-9 applies Fourier transform to each of the output audio signals converted into digital signals while shifting the window function, and converts the output audio signals into audio signals in a frequency domain. Note that instead of the STFT, band division processing such as a quadrature mirror filter (QMF) or a discrete Fourier transformation (DFT) filter bank may be performed.

The beamforming unit 403 performs beamforming for each of the divided frequency bands on the basis of the audio signals of the nine channels obtained from the STFT units 402-1 to 402-9 to emphasize a target sound or curb unnecessary noise. Many methods such as a delay-and-sum method and adaptive beamforming have been proposed for this beamforming, and any method may be used. A beamforming output is obtained from the beamforming unit 403 for each divided frequency band.

The IFFT & overlap unit 404 performs inverse Fourier transform processing of converting the beamforming output in each frequency band obtained by the beamforming unit 403 into an audio signal in a time domain and overlap-add processing to obtain a final beamforming output (beamformed audio signal), and uses the final beamforming output as an output of the audio signal output device 400.

In the audio signal processing system 30 illustrated in FIG. 3, in a case where the microphone units 302-1 to 302-9 mounted on the microphone device 300 are standard microphone units focusing on cost, the cost is low, but the sound quality is not good. On the other hand, in a case where the microphone units 302-1 to 302-9 mounted on the microphone device 300 are high-quality microphone units focusing on sound quality, the sound quality is good, but the cost is high.

“Specific Example (1) of Audio Signal Processing System”

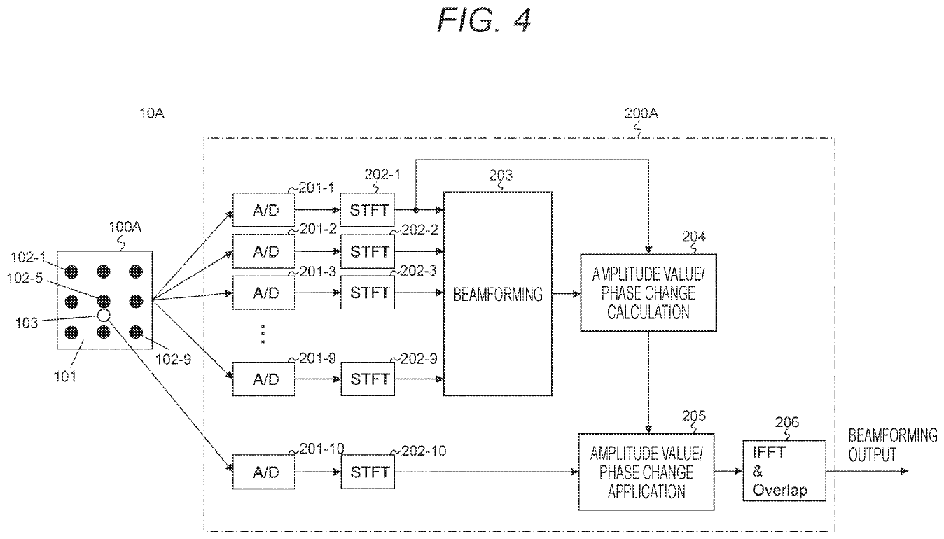

FIG. 4 illustrates a configuration example of an audio signal processing system 10A as a specific example (1) of the embodiment. The audio signal processing system 10A includes a microphone device 100A and an audio signal processing device 200A.

The microphone device 100A includes, for a plurality of channels, that is, nine in the illustrated example, standard microphone units 102-1 to 102-9 focusing on cost, and, for one channel, therefore one high-quality microphone unit 103 focusing on sound quality. Note that the number of standard microphone units focusing on cost may be any number as long as it is two or more, but in performing beamforming processing to be described later, a larger number of microphone units is advantageous in terms of sharpness of directivity.

In the microphone device 100A, the nine microphone units 102-1 to 102-9 are arranged in a 3×3 matrix in a microphone housing 101, and one microphone unit 103 is arranged at a central position of the microphone housing 101, at a position adjacent to the microphone unit 102-5 in the illustrated example. Note that the arrangement positions of the nine microphone units 102-1 to 102-9 and the one microphone unit 103 in the microphone housing 101 are not limited to the illustrated example. The microphone device 100A outputs audio signals from the microphone units 102-1 to 102-9 and 103 in parallel.

The audio signal processing device 200A includes A/D converters 201-1 to 201-10, short term Fourier transform (STFT) units 202-1 to 202-10, a beamforming unit 203, an amplitude value/phase change calculation unit 204, an amplitude value/phase change application unit 205, and an IFFT & overlap unit 206. The A/D converters 201-1 to 201-10 convert output audio signals of the microphone units 102-1 to 102-9 and 103 from analog signals to digital signals, respectively. Each of the STFT units 202-1 to 202-10 applies Fourier transform to each of the output audio signals converted into digital signals while shifting the window function, and converts the output audio signals into audio signals in a frequency domain. Note that instead of the STFT, band division processing such as a quadrature mirror filter (QMF) or a DFT filter bank may be performed.

The beamforming unit 203 performs beamforming for each of the divided frequency bands on the basis of the audio signals for the nine channels obtained from the STFT units 202-1 to 202-9 to emphasize a target sound or curb unnecessary noise. While many methods such as a delay-and-sum method and adaptive beamforming have been proposed for this beamforming, any method may be used. A beamforming output is obtained from the beamforming unit 203 for each divided frequency band.

The amplitude value/phase change calculation unit 204 calculates, for each divided frequency band, a change in amplitude value and phase of the audio signal obtained by the beamforming unit 203 with respect to the output audio signal of a reference microphone. The reference microphone may be any of the microphone units 102-1 to 102-9, and may be, for example, the central microphone unit 102-5. In the illustrated example, an audio signal obtained from the STFT unit 202-1 is used as an output audio signal of the reference microphone.

Here, an output audio signal of the reference microphone is X1(ω,t). Here, co is an angular frequency, and t is time. Furthermore, the audio signal obtained by the beamforming unit 203 is set to Y(ω,t). In this case, a change (gain) G(ω,t) of the amplitude value is obtained by the following expression (1), and a change (phase rotation amount) of the phase is obtained by the following expression (2).

G(ω,t)=|Y(ω,t)|/|X1(ω,t)| (1)

Φ(ω,t)=arg(Y(ω,t))−arg(X1(ω,t)) (2)

The amplitude value/phase change application unit 205 applies the change in the amplitude value and the phase calculated by the amplitude value/phase change calculation unit 204 to the output audio signal of the microphone 103, that is, the audio signal obtained from the STFT unit 202-10 for each divided frequency band to obtain a beamforming output.

Here, the audio signal obtained from STFT unit 202-10 is X0(ω,t). In this case, the beamforming output Y′(ω,t) is obtained by the following formula (3).

Y′(ω,t)=X0(ω,t)·G(ω,t)·e^{iφ(ω,t)} (3)

The IFFT & overlap unit 206 performs inverse Fourier transform processing of converting the beamforming output in each frequency band obtained by the amplitude value/phase change application unit 205 into an audio signal in a time domain and overlap-add processing to obtain a final beamforming output (beamformed audio signal), and uses the final beamforming output as an output of the audio signal processing device 200.

In the audio signal processing system 10A illustrated in FIG. 4, the microphone device 100A includes nine standard microphone units 102-1 to 102-9 focusing on cost and one high-quality microphone unit 103 focusing on sound quality, and can curb cost. Furthermore, in the audio signal processing system 10A illustrated in FIG. 4, a change in the amplitude value and the phase of the audio signal obtained by the beamforming unit 203 with respect to the output audio signal of the reference microphone is calculated, and the calculated change is applied to the output audio signal of the microphone 103, that is, the audio signal obtained from the SIFT unit 202-10 to obtain the beamforming output. Hence, it is possible to obtain a beamforming output with good sound quality based on a high-quality microphone unit focusing on sound quality. Therefore, the audio signal processing system 10A illustrated in FIG. 4 can perform audio signal processing that satisfies both sound quality and cost.

Note that while the audio signal processing system 10A illustrated in FIG. 4 illustrates an example in which the beamforming output is one channel, it is also conceivable to mount a plurality of high-quality microphone units focusing on sound quality on the microphone device 100A on the assumption of stereo output and apply similar phase rotation processing of beamforming to each microphone unit.

“Specific Example (2) of Audio Signal Processing System”

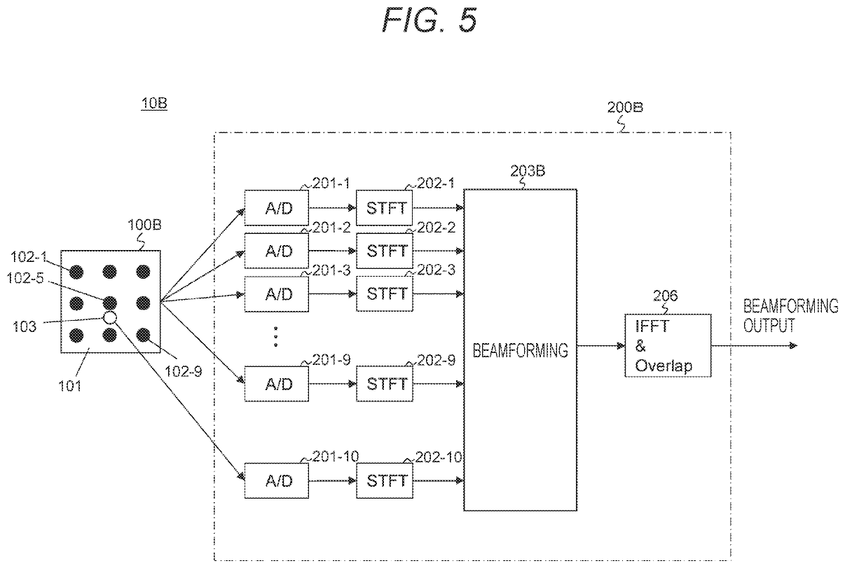

FIG. 5 illustrates a configuration example of an audio signal processing system 10B as a specific example (2) of the embodiment. In FIG. 5, a part corresponding to that in FIG. 4 is denoted by the same reference numeral, and the detailed description thereof is appropriately omitted. The audio signal processing system 10B includes a microphone device 100B and an audio signal processing device 200B.

Although detailed description is omitted, the microphone device 100B is configured similarly to the microphone device 100A in FIG. 4.

The audio signal processing device 200B includes A/D converters 201-1 to 201-10, SIFT units 202-1 to 202-10, a beamforming unit 203B, and an IFFT & overlap unit 206.

The A/D converters 201-1 to 201-10 convert output audio signals of the microphone units 102-1 to 102-9 and 103 from analog signals to digital signals, respectively. Each of the STFT units 202-1 to 202-10 applies Fourier transform to each of the output audio signals converted into digital signals while shifting the window function, and converts the output audio signals into audio signals in a frequency domain.

The beamforming unit 203B performs beamforming for each of the divided frequency bands on the basis of the audio signals for 10 channels obtained from the STFT units 202-1 to 202-10 to emphasize a target sound or curb unnecessary noise. In this case, in the beamforming unit 203B, adaptive beamforming using the microphone unit 103 as a reference microphone is performed. A beamforming output is obtained from the beamforming unit 203B for each divided frequency band.

The IFFT & overlap unit 206 performs inverse Fourier transform processing of converting the beamforming output in each frequency band obtained by the beamforming unit 203B into an audio signal in a time domain and overlap-add processing to obtain a final beamforming output (beamformed audio signal), and uses the final beamforming output as an output of the audio signal processing device 200B.

In the audio signal processing system 10B illustrated in FIG. 5, the microphone device 100B includes nine standard microphone units 102-1 to 102-9 focusing on cost and one high-quality microphone unit 103 focusing on sound quality, and can curb cost. Furthermore, in the audio signal processing system 10B illustrated in FIG. 5, adaptive beamforming using the microphone unit 103 as a reference microphone is performed to obtain a beamforming output. Hence, it is possible to obtain a beamforming output with good sound quality based on a high-quality microphone unit focusing on sound quality. Therefore, the audio signal processing system 10B illustrated in FIG. 5 can perform audio signal processing that satisfies both sound quality and cost.

(B. Example of Performing Processing for Obtaining sound source separation output)

Next, an example in which the audio signal processing device 200 performs processing for obtaining a sound source separation output will be described.

“Specific Example (3) of Audio Signal Processing System”

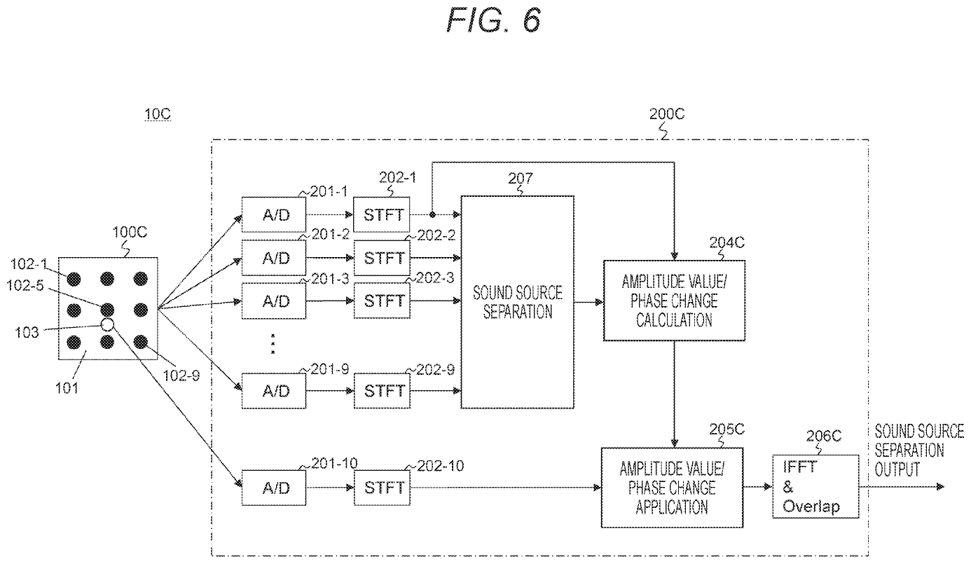

FIG. 6 illustrates a configuration example of an audio signal processing system 10C as a specific example (3) of the embodiment. In FIG. 6, a part corresponding to that in FIG. 4 is denoted by the same reference numeral, and the detailed description thereof is appropriately omitted. The audio signal processing system 10C includes a microphone device 100C and an audio signal processing device 200C.

Although detailed description is omitted, the microphone device 100C is configured similarly to the microphone device 100A in FIG. 4.

The audio signal processing device 200C includes A/D converters 201-1 to 201-10, SIFT units 202-1 to 202-10, a sound source separation unit 207, an amplitude value/phase change calculation unit 204C, an amplitude value/phase change application unit 205C, and an IFFT & overlap unit 206C.

The A/D converters 201-1 to 201-10 convert output audio signals of the microphone units 102-1 to 102-9 and 103 from analog signals to digital signals, respectively. Each of the STFT units 202-1 to 202-10 applies Fourier transform to each of the output audio signals converted into digital signals while shifting the window function, and converts the output audio signals into audio signals in a frequency domain.

The sound source separation unit 207 separates audio signals for each sound source on the basis of audio signals for nine channels obtained from the STFT units 202-1 to 202-9. For this sound source separation, many methods using independent component analysis (ICA), independent low-rank matrix analysis (ILRMA), deep neural network (DNN), and the like have been proposed, but any method may be used. From the sound source separation unit 207, a predetermined number, which is three in the illustrated example, of audio signals are obtained for each divided frequency band.

The amplitude value/phase change calculation unit 204C operates similarly to the amplitude value/phase change calculation unit 204 in FIG. 4, and calculates, for each of the divided frequency bands, a change in the amplitude value and the phase of each of the three audio signals obtained by the sound source separation unit 207 with respect to the output audio signal of the reference microphone. The reference microphone may be any of the microphone units 102-1 to 102-9, and may be, for example, the central microphone unit 102-5. In the illustrated example, an audio signal obtained from the SIFT unit 202-1 is used as an output audio signal of the reference microphone.

The amplitude value/phase change application unit 205C operates similarly to the amplitude value/phase change application unit 204 in FIG. 4, and applies the change in the amplitude value and the phase of each of the three audio signals calculated by the amplitude value/phase change calculation unit 204 to the output audio signal of a microphone 103, that is, the audio signal obtained from the SIFT unit 202-10 for each divided frequency band to obtain a sound source separation output.

The IFFT & overlap unit 206C performs inverse Fourier transform processing of converting the three sound source separated outputs in each frequency band obtained by the amplitude value/phase change application unit 205C into an audio signal in a time domain and overlap-add processing for each sound source separated output to obtain final three sound source separated outputs, and uses the final three sound source separated outputs as an output of the audio signal processing device 200C.

In the audio signal processing system 10C illustrated in FIG. 6, the microphone device 100C includes nine standard microphone units 102-1 to 102-9 focusing on cost and one high-quality microphone unit 103 focusing on sound quality, and can curb cost.

Furthermore, in the audio signal processing system 10C illustrated in FIG. 6, changes in the amplitude value and the phase of the three audio signals obtained by the sound source separation unit 207 with respect to the output audio signal of the reference microphone are calculated, and the calculated changes are applied to the output audio signal of the microphone 103, that is, the audio signal obtained from the SIFT unit 202-10 to obtain three sound source separation outputs. Hence, it is possible to obtain a sound source separation output with good sound quality based on a high-quality microphone unit focusing on sound quality. Therefore, the audio signal processing system 10C illustrated in FIG. 6 can perform audio signal processing that satisfies both sound quality and cost.

“Specific Example (4) of Audio Signal Processing System”

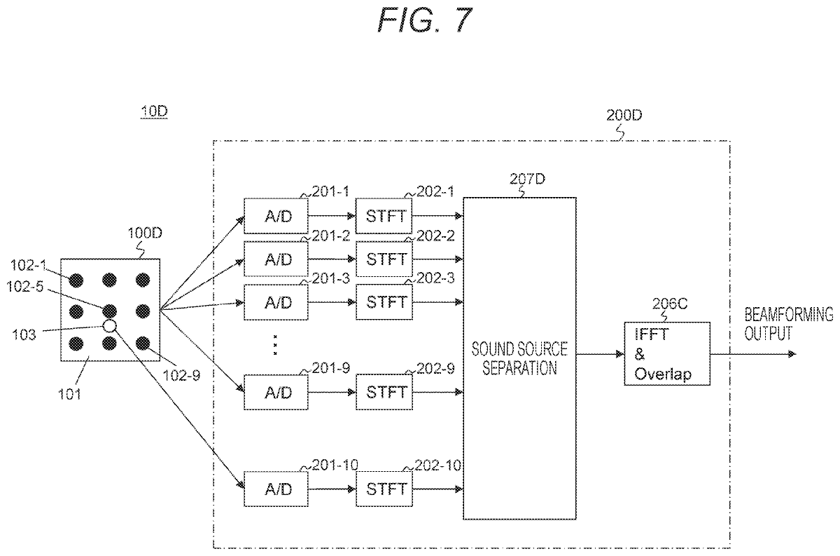

FIG. 7 illustrates a configuration example of an audio signal processing system 10D as a specific example (4) of the embodiment. In FIG. 7, a part corresponding to that in FIG. 6 is denoted by the same reference numeral, and the detailed description thereof is appropriately omitted. The audio signal processing system 10D includes a microphone device 100D and an audio signal processing device 200D.

Although detailed description is omitted, the microphone device 100D is configured similarly to the microphone device 100C in FIG. 6.

The audio signal processing device 200D includes A/D converters 201-1 to 201-10, STFT units 202-1 to 202-10, a sound source separation unit 207D, and an IFFT & overlap unit 206C.

The A/D converters 201-1 to 201-10 convert output audio signals of the microphone units 102-1 to 102-9 and 103 from analog signals to digital signals, respectively. Each of the STFT units 202-1 to 202-10 applies Fourier transform to each of the output audio signals converted into digital signals while shifting the window function, and converts the output audio signals into audio signals in a frequency domain.

The sound source separation unit 207D separates audio signals for each sound source on the basis of audio signals for 10 channels obtained from the STFT units 202-1 to 202-9 and 103. In this case, the sound source separation unit 207D performs sound source separation using the microphone unit 103 as a reference microphone. From the sound source separation unit 207D, a predetermined number, which is three in the illustrated example, of audio signals are obtained for each divided frequency band.

The IFFT & overlap unit 206C performs inverse Fourier transform processing of converting the three sound source separated outputs in each frequency band obtained by the sound source separation unit 207D into an audio signal in a time domain and overlap-add processing for each sound source separated output to obtain final three sound source separated outputs, and uses the final three sound source separated outputs as an output of the audio signal processing device 200D.

In the audio signal processing system 10D illustrated in FIG. 7, the microphone device 100D includes nine standard microphone units 102-1 to 102-9 focusing on cost and one high-quality microphone unit 103 focusing on sound quality, and can curb cost. Furthermore, in the audio signal processing system 10D illustrated in FIG. 7, sound source separation using the microphone unit 103 as a reference microphone is performed to obtain a sound source separation output. Hence, it is possible to obtain a sound source separation output with good sound quality based on a high-quality microphone unit focusing on sound quality. Therefore, the audio signal processing system 10D illustrated in FIG. 7 can perform audio signal processing that satisfies both sound quality and cost.

(C. Example of Performing Each of Processing Based on Output Audio Signal of High-Quality Microphone Unit and Processing Based on Output Audio Signal o Standard Microphone Unit)

Next, an example in which the audio signal processing device 200 performs each of processing based on an output audio signal of a high-quality microphone unit and processing based on an output audio signal of a standard microphone unit will be described. “Specific Example (5) of Audio Signal Processing System”

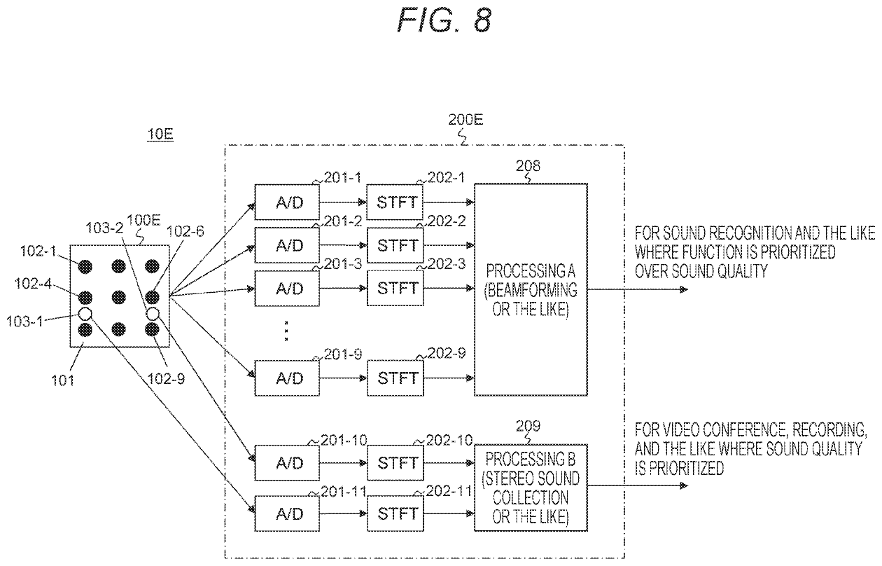

FIG. 8 illustrates a configuration example of an audio signal processing system 10E as a specific example (5). In FIG. 8, a part corresponding to that in FIG. 4 is denoted by the same reference numeral, and the detailed description thereof is appropriately omitted. The audio signal processing system 10E includes a microphone device 100E and an audio signal processing device 200E.

The microphone device 100E includes, for a plurality of channels, that is, nine in the illustrated example, standard microphone units 102-1 to 102-9 focusing on cost, and, for two channels, therefore two high-quality microphone units 103-1 and 103-2 focusing on sound quality. Note that the number of standard microphone units focusing on cost may be any number as long as it is two or more, but in performing beamforming processing to be described later, a larger number of microphone units is advantageous in terms of sharpness of directivity.

In the microphone device 100E, nine microphone units 102-1 to 102-9 are arranged in a 3×3 matrix in a microphone housing 101, and two microphone units 103-1 and 103-2 are arranged at left and right positions of the microphone housing 101 at positions adjacent to the microphone units 102-4 and 102-6 in the illustrated example. Note that the arrangement positions of the nine microphone units 102-1 to 102-9 and the two microphone units 103-1 and 103-2 in the microphone housing 101 are not limited to the illustrated example. The microphone device 100E outputs audio signals from the microphone units 102-1 to 102-9, 103-1, and 103-2 in parallel.

The audio signal processing device 200E includes A/D converters 201-1 to 201-11, STFT units 202-1 to 202-11, a processing A unit 208, and a processing B unit 209.

The A/D converters 201-1 to 201-11 convert output audio signals of the microphone units 102-1 to 102-9,103-1, and 103-2 from analog signals to digital signals, respectively. Each of the STFT units 202-1 to 202-11 applies Fourier transform to each of the output audio signals converted into digital signals while shifting the window function, and converts the output audio signals into audio signals in a frequency domain.

The processing A unit 208 performs processing such as beamforming on the basis of audio signals for nine channels obtained from the STFT units 202-1 to 202-9 related to the standard microphone units 102-1 to 102-9 focusing on cost, and obtains an output audio signal. This output audio signal can be used for a case such as sound recognition where a noise reduction function is prioritized over the sound quality of a microphone.

The processing B unit 209 performs processing such as stereo sound collection on the basis of audio signals for two channels obtained from the STFT unit 202-10 and 202-11 related to the high-quality microphone units 103-1 and 103-2 focusing on sound quality, and obtains an output audio signal. This output audio signal can be used for a case such as a video conference where sound quality is prioritized.

In the audio signal processing system 10E illustrated in FIG. 8, the microphone device 100A includes nine standard microphone units 102-1 to 102-9 focusing on cost and two high-quality microphone units 103-1 and 103-2 focusing on sound quality, and can curb cost. Furthermore, in the audio signal processing system 10E illustrated in FIG. 8, a standard microphone unit focusing on cost and a high-quality microphone unit focusing on sound quality are selectively used according to the application, and audio signal processing satisfying both sound quality and cost can be performed.

Note that in the audio signal processing system 10E illustrated in FIG. 8, the microphone device 100E includes two high-quality microphone units 103-1 and 103-2. However, a configuration including only a small amount such as one or three high-quality microphone units is also conceivable. Furthermore, the audio signal processing system that selectively uses a standard microphone unit focusing on cost and a high-quality microphone unit focusing on sound quality mounted on the microphone device according to the application is not limited to the configuration example illustrated in FIG. 8. For example, the content of the processing does not matter as long as the result of the processing performed by the processing A unit 208 and the result of the processing performed by the processing B unit 209 can be used separately by applications in the subsequent stage. The processing performed by the processing A unit 208 and the processing performed by the processing B unit 209 are not necessarily different, and may be the same in some cases.

As described above, in the audio signal processing system 10 illustrated in FIG. 1, processing based on the output audio signal of the first microphone unit focusing on sound quality and the output audio signal of the second microphone unit focusing on cost is performed, and audio signal processing (e.g., beamforming processing, sound source separation processing, and the like) satisfying both sound quality and cost can be performed.

<2. Modification>

Note that although not described above, the microphone device 100 and the audio signal processing device 200 may be integrally formed.

Furthermore, while the preferred embodiments of the present disclosure have been described in detail with reference to the accompanying drawings, the technical scope of the present disclosure is not limited to such examples. It will be apparent to those skilled in the art of the present disclosure that various changes or modifications can be conceived within the scope of the technical idea described in the claims. It is understood that these also belong to the technical scope of the present disclosure, as a matter of course.

Furthermore, the effects described in the present specification are merely illustrative or exemplary, and are not limiting. That is, the technology according to the present disclosure can exhibit other effects apparent to those skilled in the art from the description of the present specification, in addition to or instead of the effects described above.

Furthermore, the technology can also have the following configurations.

(1) A microphone device including
a first microphone unit and a second microphone unit having different sizes or different parameters related to sound quality.

(2) The microphone device according to (1) above, in which
both the first microphone unit and the second microphone unit are provided in one housing.

(3) The microphone device according to (1) or (2) above, in which
the first microphone unit and the second microphone unit have different microphone diameters.

(4) The microphone device according to any one of (1) to (3) above, in which
the first microphone unit and the second microphone unit have different frequency characteristics.

(5) The microphone device according to any one of (1) to (4) above, in which
the first microphone unit and the second microphone unit have different self-noise levels.

(6) The microphone device according to any one of (1) to (5) above, in which
the first microphone unit and the second microphone unit have different maximum input sound pressure levels.

(7) The microphone device according to any one of (1) to (6) above, in which
the number of the first microphone units is one or two, and the number of the second microphone units is at least two.

(8) An audio signal processing device including
a processing unit that performs processing based on an output audio signal of a first microphone unit and an output audio signal of a second microphone unit, in which
the first microphone unit and the second microphone unit have different sizes or different parameters related to sound quality.

(9) The audio signal processing device according to (8) above, in which
the processing performed by the processing unit includes processing of obtaining a beamforming output.

(10) The audio signal processing device according to (9) above, in which
the processing performed by the processing unit includes beamforming processing based on output audio signals of a plurality of the second microphone units, processing of calculating a change in an amplitude value and a phase of an audio signal obtained by the beamforming processing with respect to an output audio signal of a reference microphone which is one of the plurality of second microphone units, and processing of generating the beamforming output by applying the change in the amplitude value and the phase obtained by the calculation processing to the output audio signal of the first microphone unit.

(11) The audio signal processing device according to (9) above, in which
the processing performed by the processing unit includes processing of generating the beamforming output by performing adaptive beamforming using the first microphone unit as a reference microphone on the basis of output audio signals of a plurality of the second microphone units and the first microphone unit.

(12) The audio signal processing device according to (8) above, in which
the processing performed by the processing unit includes processing of obtaining a sound source separation output.

(13) The audio signal processing device according to (12) above, in which
the processing performed by the processing unit includes sound source separation processing based on output audio signals of a plurality of the second microphone units, processing of calculating a change in an amplitude value and a phase of an audio signal obtained by the sound source separation processing with respect to an output audio signal of a reference microphone which is one of the plurality of second microphone units, and processing of generating the sound source separation output by applying the change in the amplitude value and the phase obtained by the calculation processing to the output audio signal of the first microphone unit.

(14) The audio signal processing device according to (12) above, in which
the processing performed by the processing unit includes processing of generating the sound source separation output by performing sound source separation using the first microphone unit as a reference microphone on the basis of output audio signals of a plurality of the second microphone units and the first microphone unit.

(15) The audio signal processing device according to (8) above, in which
the processing performed by the processing unit includes processing of generating a first audio signal on the basis of an output audio signal of the first microphone and processing of generating a second audio signal on the basis of an output audio signal of the second microphone unit.

(16) The audio signal processing device according to any one of (8) to (15) above, further including
a microphone device including the first microphone unit and the second microphone unit.

(17) An audio signal processing method including
a procedure of performing processing based on an output audio signal of a first microphone unit and an output audio signal of a second microphone unit, in which
the first microphone unit and the second microphone unit have different sizes or different parameters related to sound quality.

### REFERENCE SIGNS LIST

10, 10A to 10E Audio signal processing system

100, 100A to 100E Microphone device

101 Microphone housing

102-1 to 102-9 Standard microphone unit focusing on cost

103, 103-1, 103-2 High-quality microphone unit focusing on sound quality

200, 200A to 200E Audio signal processing device

201-1 to 201-11 A/D converter

202-1 to 202-11 SIFT unit

203, 203B Beamforming unit

204204C, Amplitude value/phase change calculation unit

205, 205C Amplitude value/phase change application unit

206, 206C IFFT & overlap unit

207, 207D Sound source separation unit

208 Processing A unit

209 Processing B unit

1. A microphone device comprising
a first microphone unit and a second microphone unit having different sizes or different parameters related to sound quality.

2. The microphone device according to claim 1, wherein
both the first microphone unit and the second microphone unit are provided in one housing.

3. The microphone device according to claim 1, wherein
the first microphone unit and the second microphone unit have different microphone diameters.

4. The microphone device according to claim 1, wherein
the first microphone unit and the second microphone unit have different frequency characteristics.

5. The microphone device according to claim 1, wherein
the first microphone unit and the second microphone unit have different self-noise levels.

6. The microphone device according to claim 1, wherein
the first microphone unit and the second microphone unit have different maximum input sound pressure levels.

7. The microphone device according to claim 1, wherein
the number of the first microphone units is one or two, and the number of the second microphone units is at least two.

8. An audio signal processing device comprising
a processing unit that performs processing based on an output audio signal of a first microphone unit and an output audio signal of a second microphone unit, wherein
the first microphone unit and the second microphone unit have different sizes or different parameters related to sound quality.

9. The audio signal processing device according to claim 8, wherein
the processing performed by the processing unit includes processing of obtaining a beamforming output.

10. The audio signal processing device according to claim 9, wherein
the processing performed by the processing unit includes beamforming processing based on output audio signals of a plurality of the second microphone units, processing of calculating a change in an amplitude value and a phase of an audio signal obtained by the beamforming processing with respect to an output audio signal of a reference microphone which is one of the plurality of second microphone units, and processing of generating the beamforming output by applying the change in the amplitude value and the phase obtained by the calculation processing to the output audio signal of the first microphone unit.

11. The audio signal processing device according to claim 9, wherein
the processing performed by the processing unit includes processing of generating the beamforming output by performing adaptive beamforming using the first microphone unit as a reference microphone on a basis of output audio signals of a plurality of the second microphone units and the first microphone unit.

12. The audio signal processing device according to claim 8, wherein
the processing performed by the processing unit includes processing of obtaining a sound source separation output.

13. The audio signal processing device according to claim 12, wherein
the processing performed by the processing unit includes sound source separation processing based on output audio signals of a plurality of the second microphone units, processing of calculating a change in an amplitude value and a phase of an audio signal obtained by the sound source separation processing with respect to an output audio signal of a reference microphone which is one of the plurality of second microphone units, and processing of generating the sound source separation output by applying the change in the amplitude value and the phase obtained by the calculation processing to the output audio signal of the first microphone unit.

14. The audio signal processing device according to claim 12, wherein
the processing performed by the processing unit includes processing of generating the sound source separation output by performing sound source separation using the first microphone unit as a reference microphone on a basis of output audio signals of a plurality of the second microphone units and the first microphone unit.

15. The audio signal processing device according to claim 8, wherein
the processing performed by the processing unit includes processing of generating a first audio signal on a basis of an output audio signal of the first microphone and processing of generating a second audio signal on a basis of an output audio signal of the second microphone unit.

16. The audio signal processing device according to claim 8, further comprising
a microphone device including the first microphone unit and the second microphone unit.

17. An audio signal processing method comprising
a procedure of performing processing based on an output audio signal of a first microphone unit and an output audio signal of a second microphone unit, wherein the first microphone unit and the second microphone unit have different sizes or different parameters related to sound quality.
